(19) United States
(12) Patent Application Publication
(10) Pub. No.: US 2026/0292610 A1
(43) Pub. Date: Sep. 24, 2026

(54) METHODS FOR TIERED RADIO RESOURCE MANAGEMENT WITH CONNECTED-MODE MOBILITY MANAGEMENT IN MOBILE COMMUNICATIONS

(71) Applicant: MEDIATEK INC., Hsinchu City (TW)

(72) Inventors: Din-Hwa HUANG, Hsinchu City (TW); Chia-Hao YU, Hsinchu City (TW); Cheng-Hsun LI, Hsinchu City (TW); Pei-Kai LIAO, Hsinchu City (TW)

(21) Appl. No.: 19/473,499

(22) PCT Filed: Dec. 12, 2024
(86) PCT No.: PCT/CN2024/138647

§ 371 Date: Oct. 8, 2025

Related U.S. Application Data
(60) Provisional application No. 63/608,898, filed on Dec. 12, 2023.
(60) Provisional application No. 63/608,899, filed on Dec. 12, 2023.

(51) Int. Cl. H04W 36/00; H04B 7/06; H04L 5/00; H04W 24/10; H04W 56/00; H04W 74/0833

(52) U.S. Cl. CPC H04W 36/0058; H04B 7/0626; H04L 5/0051; H04W 24/10; H04W 56/0015; H04W 56/0045; H04W 74/0833

(57) ABSTRACT

Various solutions for tiered radio resource management (RRM) with connected-mode mobility management are described. An apparatus may connect to one or more network nodes within a single frequency network (SFN) area to operate in a connected mode. Then, the apparatus may enable a first RRM by performing a first measurement of a first downlink (DL) reference signal (RS) received from the network nodes. The first DL RS may include identification information of the SFN area without identification information of any of the network nodes. Also, the apparatus may enable a second RRM by performing a second measurement of a second DL RS received from network nodes or by transmitting an uplink (UL) RS to the network nodes. The second DL RS may include identification information of the network nodes. After that, the apparatus may perform a network node switching procedure based on a result of the first measurement and the second measurement.

### CROSS REFERENCE TO RELATED PATENT APPLICATION(S)

The present disclosure is part of a non-provisional application claiming the priority benefit of U.S. Patent Application No. 63/608,898, filed 12 Dec. 2023, and U.S. Patent Application No. 63/608,899, filed 12 Dec. 2023. The contents of aforementioned applications are herein incorporated by reference in their entirety.

### TECHNICAL FIELD

The present disclosure is generally related to mobile communications and, more particularly, to tiered radio resource management (RRM) with connected-mode mobility management with respect to user equipment (UE) and network node in mobile communications.

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using one or more cells to form a radio access network. The BS may support the operations of the cell(s), and each cell may be operable to provide services to at least one UE within its radio coverage. In order to reduce inter-cell interference, a multiple transmission reception points (TRPs) architecture is supported in 5th generation (5G) New Radio (NR) by allowing dynamic coordination between the multi-TRPs to provide joint scheduling and transmissions/receptions. As such, a UE, e.g., at the cell edge, may be served by multi-TRPs to improve its signal transmission/reception, which contributes to increased throughput.

However, there are some issues with the current framework of RRM and mobility management in 5G NR. For example, the current synchronization signal block (SSB) design is node and beam aware, where each TRP transmits a respective SSB in a beam sweeping manner and the UE needs to perform beam sweeping for monitoring the SSB from each TRP. This SSB design not only causes increased power consumption (e.g., due to the beamforming operations) for both UE and network (NW), but also results in inefficient radio resource utilization (e.g., due to different SSBs having mostly the same content other than the physical broadcast channel (PBCH) part). Furthermore, this SSB design may result in more frequent cell switching for connected-mode UE under dense network deployment, and the RRM latency for connected-mode UE under dense network deployment may lead to slow cell switching which further causes throughput degradation at the cell-edge.

Accordingly, how to improve the framework of RRM and mobility management becomes an important topic for modern wireless communication systems. Therefore, there is a need to provide proper schemes to address the above-described issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to tiered RRM with connected-mode mobility management in mobile communications. It is believed that the above-described issues would be avoided or otherwise alleviated by implementing one or more of the proposed schemes described herein.

In one aspect, a method may involve an apparatus (e.g., UE) connecting to one or more network nodes within a single frequency network (SFN) area to operate in a connected mode. The method may also involve the apparatus enabling a first RRM by performing a first measurement of a first downlink (DL) reference signal (RS) received from the network nodes, wherein the first DL RS comprises identification information of the SFN area without identification information of any of the network nodes. The method may further involve the apparatus enabling a second RRM by performing a second measurement of a second DL RS received from the network nodes or by transmitting an uplink (UL) RS to the network nodes, wherein the second DL RS comprises identification information of the network nodes. Furthermore, the method may further involve the apparatus performing a network node switching procedure based on a result of the first measurement and the second measurement.

In one aspect, a method may involve a network node (e.g., a TRP or a radio unit (RU)) within an SFN area, connecting with an apparatus to enable the apparatus to operate in a connected mode. The method may also involve the network node enabling a first RRM by transmitting a first DL RS to the apparatus, wherein the first DL RS is the same as other first DL RSs transmitted by other network nodes within the SFN area, and the first DL RS comprises identification information of the SFN area without identification information of any of the network nodes. The method may further involve the network node enabling a second RRM by transmitting a second DL RS to the apparatus or by performing a first measurement of an UL RS received from the apparatus, wherein the second DL RS is different from other second DL RSs transmitted by other network nodes within the SFN area, and the second DL RS comprises identification information of the network node. Furthermore, the method may further involve the network node performing a network node switching procedure associated with the apparatus based on the first DL RS transmission and the second DL RS transmission.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of the current framework of RRM and mobility management in 5G NR.

FIG. 2 is a diagram depicting an example scenario of tiered RRM with mobility management in accordance with an implementation of the present disclosure.

FIG. 3 is a diagram depicting an example scenario of tiered RRM framework in accordance with an implementation of the present disclosure.

FIG. 4 is a diagram depicting an example scenario of mobility management based on the tiered RRM framework in accordance with an implementation of the present disclosure.

FIG. 5 is a diagram depicting an example scenario of tiered RRM with idle-mode mobility management in accordance with an implementation of the present disclosure.

FIG. 6 is a diagram depicting an example scenario of tiered RRM with connected-mode mobility management in accordance with an implementation of the present disclosure.

FIG. 7 is a diagram depicting an example scenario of TRP set selection for intra-SFN inter-TRP mobility in accordance with an implementation of the present disclosure.

FIG. 8 is a diagram depicting two example scenarios of TRP set selection for inter-SFN mobility in accordance with an implementation of the present disclosure.

FIG. 9 is a diagram depicting an example scenario of DL-based TRP set selection using 2-step RACH procedure in accordance with an implementation of the present disclosure.

FIG. 10 is a diagram depicting an example scenario of DL-based TRP set selection using 4-step RACH procedure in accordance with an implementation of the present disclosure.

FIG. 11 is a diagram depicting an example scenario of derivation/adjustment of the clock error between TRPs in accordance with an implementation of the present disclosure.

FIG. 12 is a diagram depicting an example scenario of determination of TA of multiple TRPs in accordance with an implementation of the present disclosure.

FIG. 13 is a diagram depicting an example scenario of RACH-based UL-assisted TRP set selection in accordance with an implementation of the present disclosure.

FIG. 14 is a diagram depicting an example scenario of SRS-based UL-assisted TRP set selection in accordance with an implementation of the present disclosure.

FIG. 15 is a block diagram of an example communication system in accordance with an implementation of the present disclosure.

FIG. 16 is a flowchart of an example process in accordance with an implementation of the present disclosure.

FIG. 17 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to tiered RRM with connected-mode mobility management in mobile communications. According to the present disclosure, a number of possible solutions may be implemented separately or jointly. That is, although these possible solutions may be described below separately, two or more of these possible solutions may be implemented in one combination or another.

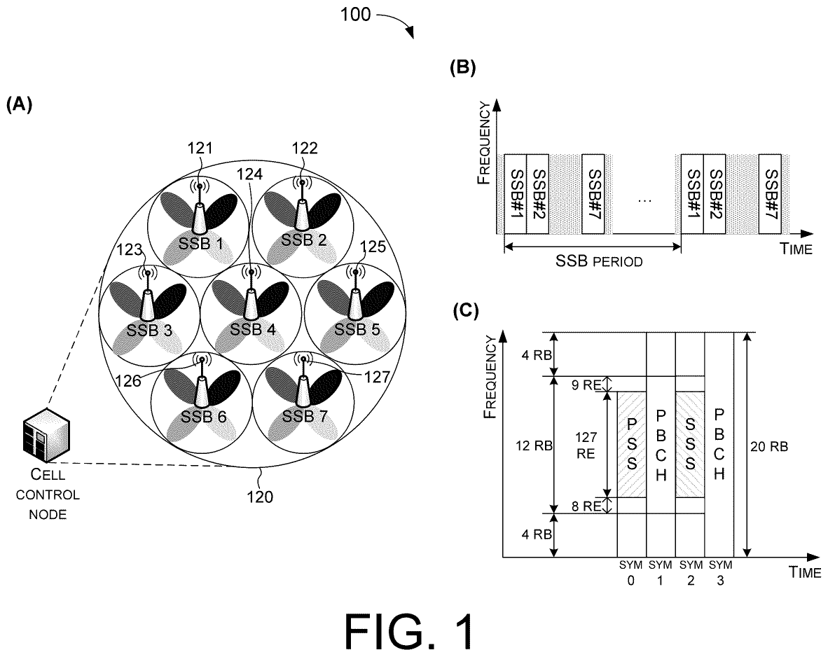

In 5G NR, the current framework of RRM and mobility management is based on the node and beam aware SSB design. FIG. 1 illustrates an example scenario 100 of the current framework of RRM and mobility management in 5G NR. Part (A) of FIG. 1 depicts multiple TRPs 121-127 within a cell 120, where each of the TRPs 121-127 transmits a respective SSB (denoted as SSB 1 to SSB 7) in a beam sweeping manner. Part (B) of FIG. 1 depicts the time and frequency resource allocation for the SSB transmissions of all TRPs within the cell 120, where the SSBs of different TRPs are transmitted in separate time domain resources within the SSB period. Part (C) of FIG. 1 depicts the SSB structure including a primary synchronization signal (PSS) and a secondary synchronization signal (SSS) for synchronization purpose, and a PBCH which contains the demodulation reference signal (DMRS) and data. For example, the PSS and/or the SSS may carry the cell identifier (ID) of the cell 120, and the PBCH may carry master information block (MIB) information and SSB index. For a UE (not shown) within the cell coverage, it may detect the following information from the SSB(s): (i) the cell ID for identifying the cell 120, (ii) the SSB index for identifying a TRP, (iii) the PBCH content other than the SSB index information, which has been transmitted repeatedly for multiple times, and it cannot be saved from transmission due to the beam sweeping architecture in frequency range 2 (FR2), and (iv) L1/L3 measurement RS which are combined as an SSB. However, as mentioned previously, this SSB design not only causes increased power consumption (e.g., due to the beamforming operations) for both UE and NW, but also results in inefficient radio resource utilization (e.g., due to different SSBs having mostly the same content other than the PBCH part). Furthermore, this SSB design may result in more frequent cell switching for connected-mode UE under dense network deployment, and the RRM latency for connected-mode UE under dense network deployment may lead to slow cell switching which further causes throughput degradation at the cell-edge.

In view of the above, the present disclosure proposes a number of schemes pertaining to tiered RRM with connected-mode mobility management in mobile communications, aiming to solve the above-described issues. According to the schemes of the present disclosure, a tiered framework of RRM and mobility management is provided to enhance overall system performance with respect to UE and network operations in connected mode (e.g., radio resource control (RRC) connected mode).

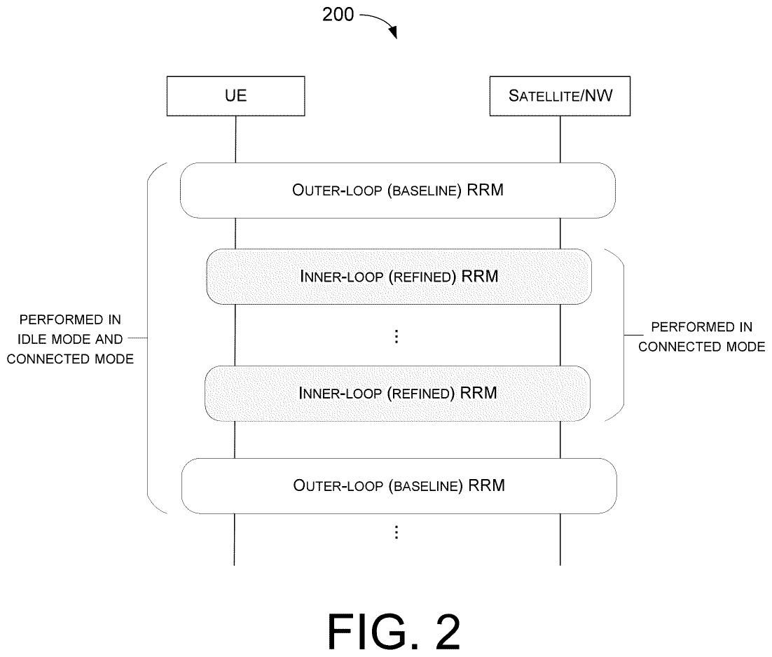

Under the first proposed scheme of the present disclosure, a tiered RRM may involve a low-overhead outer-loop RRM and optionally, a low-complexity inner-loop RRM. FIG. 2 illustrates an example scenario 200 of tiered RRM with mobility management in accordance with an implementation of the present disclosure. The outer-loop RRM may be a global/coarse view of the RRM (or called baseline RRM) made available to the network through UE feedback based on UE's measurement of DL cell-specific broadcast signal/channel (e.g., SFN SSB) or through NW's measurement of UL RS/channel (e.g., physical random access channel (PRACH) signal or sounding reference signal (SRS)) from the UE. The outer-loop RRM may be used for initiating the RRM (and/or mobility) procedure or initializing/resetting/correcting the inner-loop RRM. The inner-loop RRM may be a local/refined view of the RRM (or called refined RRM) made available to the network through UE feedback based on UE's measurement of DL TRP-specific broadcast signal/channel (e.g., TRP RS) or through NW's measurement of UL RS/channel (e.g., PRACH signal or SRS) from the UE. The inner-loop RRM may be used for tracking the RRM between the occurrence of the outer-loop RRM occasions with higher spatial resolution (on NW nodes).

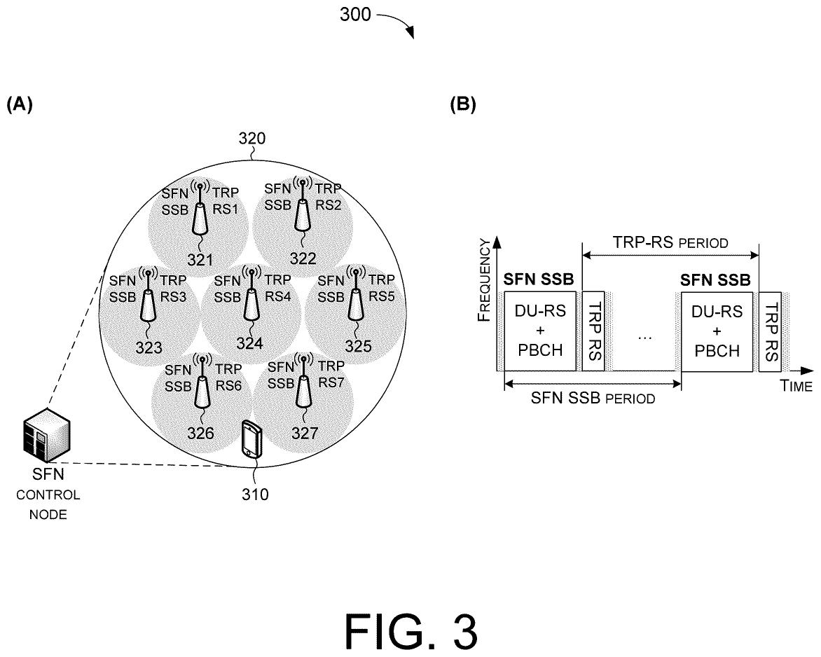

FIG. 3 illustrates an example scenario 300 of tiered RRM framework in accordance with an implementation of the present disclosure. Part (A) of FIG. 3 depicts a communication environment involving a UE 310 in wireless communication with one or more of multiple TRPs (or RUs) 321-327 within an SFN area (e.g., a cell) 320, where all of the TRPs 321-327 transmits the same 1^{st}-tier DL RS, i.e., an SFN SSB, without beamforming or with beamforming that is UE transparent. Specifically, the SFN SSB includes identification information of the SFN area 320 without identification information of any of the TRPs 321-327 within the SFN area 320. That is, the SFN SSB may allow identification of a cell, but may not allow identification of a TRP within the cell coverage. In addition to the SFN SSB, each of the TRPs 321-327 also transmits a respective 2^{nd}-tier DL RS, i.e., a TRP RS. Specifically, the TRP RS includes identification information of a respective TRP (e.g., a TRP ID). That is, this TRP-specific signal may allow identification of a TRP, but may not allow identification of TRPs between different SFN areas. Part (B) of FIG. 3 depicts the time and frequency resource allocation for the SFN SSB and TRP RS transmissions of all TRPs within the SFN area 320, where the SFN SSB and the TRP RS are transmitted in separate time domain resources (e.g., the TRP RS is transmitted after the SFN SSB) to avoid resource competition between L1 measurement and L3 measurement. The UE 310 may perform (and report) a L3 measurement based on the SFN SSB for outer-loop RRM, and perform a L1 measurement based on the TRP RS for inner-loop RRM. Accordingly, the SFN control node (e.g., a distributed unit (DU) or a BS) may perform mobility management (e.g., inter-SFN mobility or intra-SFN inter-TRP mobility) of the UE 310 based on the L3 measurement, the L1 measurement, or the measurement of an UL RS/channel (e.g., PRACH signal or SRS) from the UE 310.

In some implementations, the SFN SSB may occupy a narrow bandwidth. For example, similar to the concept of synchronization signal and PBCH in 5G NR system, the SFN SSB may include a synchronization signal (or called DU-specific RS) (e.g., either both PSS and SSS, or simply one of PSS and SSS) and a PBCH.

In some implementations, the SFN SSB may be regularly transmitted. For example, the SFN SSB may be periodically or semi-periodically transmitted.

In some implementations, the TRP RS may occupy a narrow or wide bandwidth. For example, similar to the concept of synchronization signal in 5G NR system, the TRP RS may include a synchronization signal (e.g., SSS). The TRP RS may be a multi-port RS for spatial domain parameter estimation/acquisition, the TRP RS may be configurable by, e.g., broadcast information (or system information) as a form of, e.g., a channel state information-reference signal (CSI-RS), such that the pattern, resource element occupation, and bandwidth of the TRP RS would be more flexible. Additionally, or optionally, the TRP RS may be associated with more than one occasion per TRP, with each occasion is corresponding to different spatial domain properties.

In some implementations, the location (including duration, periodicity, and offset) of an SFN SSB may be within a given SSB-based measurement timing configuration (SMTC), and the location (including duration, periodicity, and offset) of a TRP RS may be within a given TRP-RS measurement timing configuration (MTC), wherein the periodicities of the SFN SSB and the TRP-RS may be different. The TRP-RS MTC may be given by SFN PBCH or broadcasted SIB information, or may be re-configured by dedicated RRC configuration.

It is noteworthy that, in the present disclosure, L3 measurement and L1 measurement are separated with different RSs, i.e., L3 measurement is performed based on SFN SSB (e.g., for cell switching), and L1 measurement is performed based on TRP RS (e.g., for beam switching). Accordingly, by applying the schemes of the present disclosure, the speed of cell/beam switching may be improved (i.e., the latency due to cell/beam switching may be reduced). More specifically, when compared with the RRM design in 5G NR, the new design of tiered RRM may have advantages, including (i) all TRPs transmit the same PBCH; (ii) all SSBs are transmitted with the same transmission (Tx) beam or with different beamforming directions; (iii) a new TRP-specific signal/channel (e.g., TRP RS) including TRP ID is introduced; and (iv) SSB may be transmitted non-beamformed (i.e., no beam operation is required for idle mode or power saving mode UE).

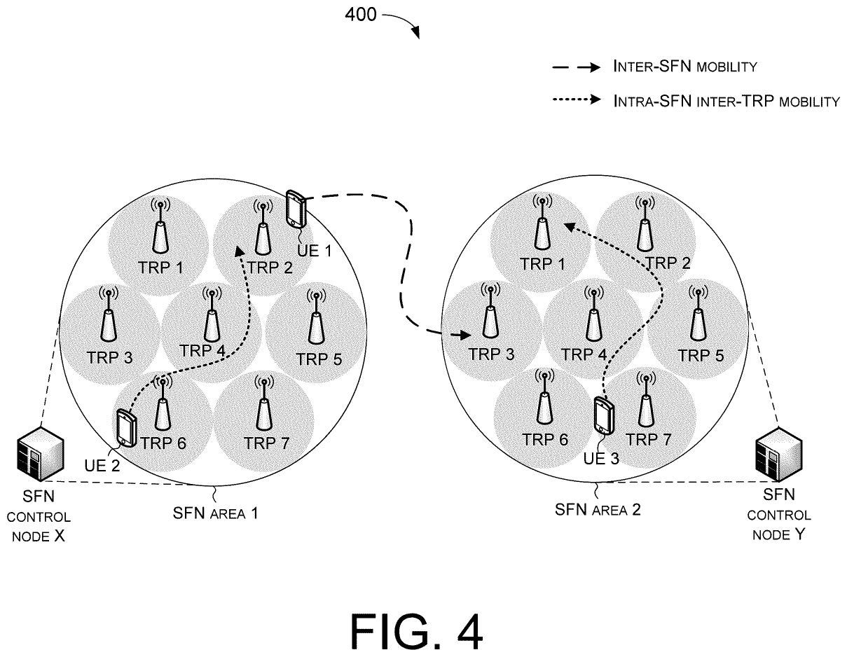

FIG. 4 illustrates an example scenario 400 of mobility management based on the tiered RRM framework in accordance with an implementation of the present disclosure. Scenario 400 depicts two types of UE's mobility, including inter-SFN mobility and intra-SFN inter-TRP mobility, in the proposed tiered framework of RRM and mobility management. As shown in FIG. 4, UE 1 undergoes an inter-SFN mobility from SFN area 1 to SFN area 2, and, more particularly, from TRP 2 of SFN area 1 to TRP 3 of SFN area 2. In addition, UE 2 undergoes an intra-SFN inter-TRP mobility within SFN area 1 (i.e., from TRP 6 of SFN area 1 to TRP 2 of SFN area 1), while UE 3 undergoes an intra-SFN inter-TRP mobility within SFN area 2 (i.e., from TRP 7 of SFN area 2 to TRP 1 of SFN area 2).

In some implementations, the inter-SFN mobility for idle mode or power saving mode UE may be based on the UE's measurement of the 1^{st}-tier DL signal (i.e., the SFN SSB), while the inter-SFN mobility for connected mode UE may be based on the UE's measurement of the 1^{st}-tier DL signal (i.e., the SFN SSB) and optionally the 2^{nd}-tier DL signal (i.e., the TRP RS).

In some implementations, the intra-SFN inter-TRP mobility may be based on the UE's measurement of the 2^{nd} tier DL signal (i.e., the TRP RS) or based on the NW's measurement of the UE's UL RS/channel (e.g., PRACH signal or SRS). For the intra-frequency case, the intra-SFN inter-TRP mobility may be based on TRP RS (DL-based) or SRS/PRACH (UL based). For the inter-frequency case, the intra-SFN inter-TRP mobility may be based on TRP RS (DL-based, need measurement gap) (e.g., based on 1 port of TRP RS if it is a multi-port signal) or PRACH (UL based).

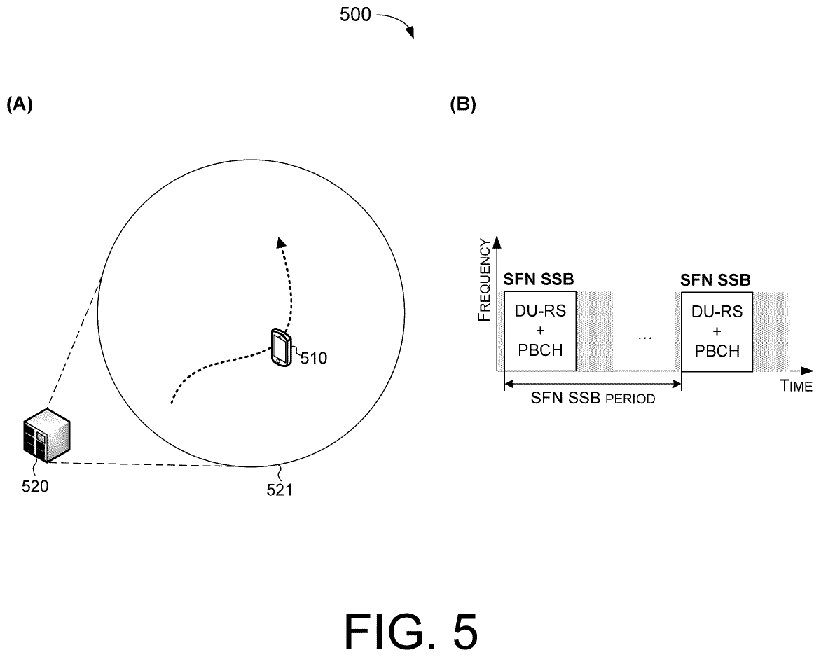

FIG. 5 illustrates an example scenario 500 of tiered RRM with idle-mode mobility management in accordance with an implementation of the present disclosure. Part (A) of FIG. 5 depicts a UE 510 in wireless communication with an SFN control node 520 (e.g., a DU or a BS), where the UE 510 is operating in the idle mode (or power saving mode) and moves within the SFN area 521 (e.g., a cell). It is noteworthy that the TRPs within the SFN area 521 are not shown because they are invisible or transparent to the UE 510 since the UE 510 only needs to monitor the SFN SSB in the idle mode (or power saving mode) and all TRPs within the SFN area 521 transmit the same SFN SSB that contains information allowing identification of a cell but not a TRP. Part (B) of FIG. 5 depicts the monitoring operation of the UE 510, which focuses on SFN SSB only, such that the UE power consumption may be reduced. The SFN SSB may include: (i) DU-RS consisting of PSS and/or SSS, which is/are generated as a small number of sequence due to large cell coverage assumption; and (ii) PBCH, which includes minimum system information (SI). In one example, the SFN SSB may be transmitted without beam sweeping in high frequency band (e.g., FR2 or FR3), and the array gain may be compensated by long DU-RS+PBCH transmission.

In some implementations, the tiered RRM in scenario 500 may be applied for an enhanced mobile broadband (eMBB) UE in idle mode or power saving mode, or may be applied for a reduced capability (ReCap) UE or an IoT UE in power saving mode.

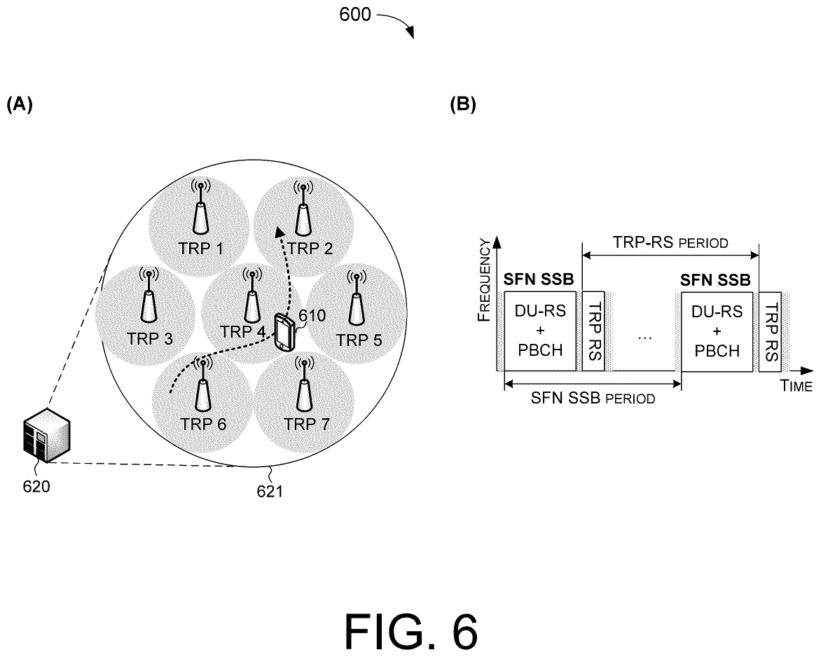

FIG. 6 illustrates an example scenario 600 of tiered RRM with connected-mode mobility management in accordance with an implementation of the present disclosure. Part (A) of FIG. 6 depicts a UE 610 in wireless communication with multiple TRPs (denoted as TRP 1 to TRP 7) controlled by an SFN control node 620 (e.g., a DU or a BS), where the UE 610 is operating in the connected mode and moves between the TRPs in the SFN area 621 (e.g., a cell). It is noteworthy that the TRPs within the SFN area 621 are shown because they are visible to the UE 610 since the UE 610 needs to monitor both the SFN SSB and the TRP RS in the connected mode and the TRP RS contains information which allows identification of a TRP. Part (B) of FIG. 6 depicts the monitoring operation of the UE 610, which focuses on both the SFN SSB and the TRP RS. The TRP-specific ID may be determined based on TRP-RS sequence. For example, the TRP RS may be allocated with resources that are time-division multiplexed (TDMed) to the SFN SSB, i.e., the SFN SSB and the TRP RS are not overlapped in the time domain, such that no resource competition between L1 measurement and L3 measurement is occurred. The TRP RSs of different TRPs may be allocated with code-division multiplexed (CDMed) resources (narrow band as SSS preferred). The TRP RS may be configurable by broadcast information. For example, The TRP RS may be a CSI-RS-like signal with flexible configuration of bandwidth, number of ports, number of Tx occasions/TRP, and/or pattern (e.g., resource elements occupancy, density), and not with CDMed across ports.

In some implementations, the tiered RRM in scenario 600 may be applied for an eMBB UE in connected mode.

In some implementations, the inter-SFN mobility may be performed based on the outer-loop RRM, while the intra-SFN inter-TRP mobility may be performed based on the inner-loop RRM. In one example, the inner-loop RRM may be based on UE's UL RS (e.g., SRS/PRACH) transmission which may be narrowband/wideband Tx and may be periodic, aperiodic, event triggered, or on-demand Tx. The Tx may be in another carrier than serving carrier, for inter-frequency RRM. The Tx may be in a first frequency section of a serving carrier, while associated reception (Rx) may be in a second frequency section of the serving cell (e.g., the first frequency section and the second frequency section may not be the same). The UE may be capable of DL serving carrier reception and UL non-serving carrier Tx at the same time (i.e., support full-duplex in different frequencies). In another example, the inner-loop RRM may be based on the UE's measurement of the TRP RS. For inter-frequency cases, measurement gap may be needed for inter-frequency TRP RS measurement.

Under the second proposed scheme of the present disclosure, the outer-loop RRM and the inner-loop RRM may enable or assist with other operations, such as TRP (or RU) set selection, i.e., selecting the TRP set for best service performance which varies with the UE's movement (which is also referred to herein as a network node switching procedure). In one example, a TRP set may contain one or more TRPs. In one example, there may be a primary TRP within the TRP set.

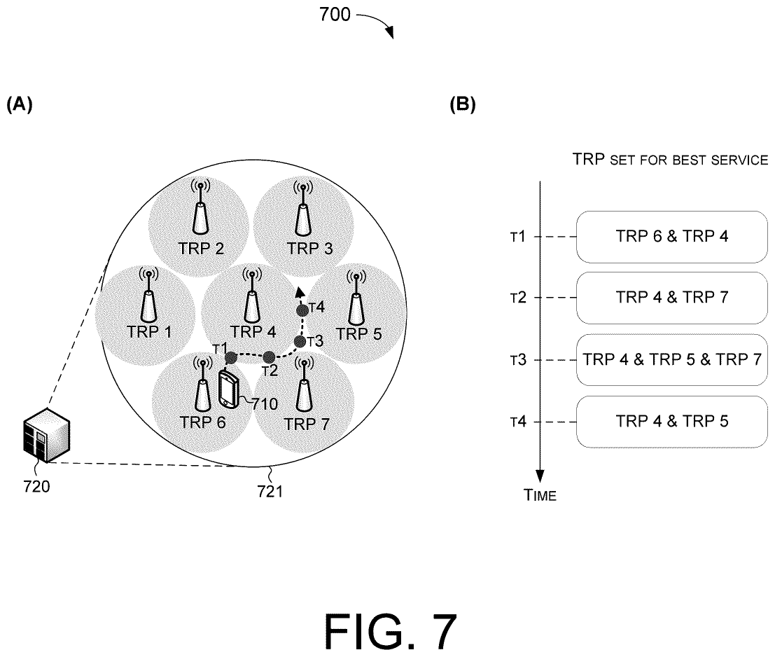

FIG. 7 illustrates an example scenario 700 of TRP set selection for intra-SFN inter-TRP mobility in accordance with an implementation of the present disclosure. Scenario 700 involves a UE 710 in wireless communication with multiple TRPs (denoted as TRP 1 to TRP 7) controlled by an SFN control node 720 (e.g., a DU or a BS), where the UE 710 is operating in the connected mode and moves between the TRPs within the SFN area 721 (e.g., a cell). As the UE 710 moves with time advancing to t1, the TRP set includes TRP 6 (as primary TRP) and TRP 4. Next, in time t2, the TRP set is updated and includes TRP 4 (as primary TRP) and TRP 7. Then, in time t3, the TRP set is updated and includes TRP 4 (as primary TRP), TRP 5, and TRP 7. Later, in time t4, the TRP set is updated and includes TRP 4 (as primary TRP) and TRP 5.

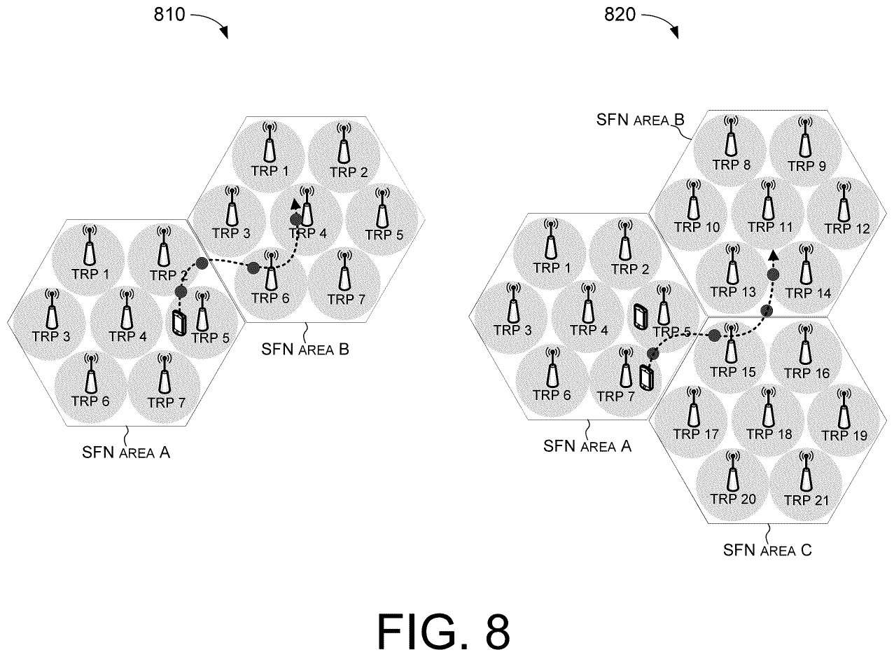

Additionally, or optionally, the TRP set selection may be UE-centric. FIG. 8 illustrates two example scenarios 810 and 820 of TRP set selection for inter-SFN mobility in accordance with an implementation of the present disclosure. In scenario 810, different UE IDs (e.g., radio network temporary identifiers (RNTIs)) are used across SFN areas (e.g., DUs/Cells). For instance, when the UE is within SFN area A, RNTIA may be used for the UE; and when the UE is within SFN area B, RNTIB may be used for the UE. In one example, the network may maintain each TRP ID unique within one SFN area. In one example, the network may maintain the UE ID unique within one SFN area. In scenario 820, a single UE ID is used across multiple SFN areas, or UE IDs used in different SFN areas are considered to be identical to the network. For instance, the RNTI(s) for the UE within SFN area A, SFN area B, and SFN area C is/are the same. In one example, the network may maintain each TRP ID unique across SFN areas. In one example, the network may also maintain the UE ID(s) unique across SFN areas.

Under the third proposed scheme of the present disclosure, a DL-based approach for TRP set selection is proposed. Specifically, the DL-based approach may be realized based on a 2-step or 4-step procedure. In one example, the 2-step procedure may be a contention-free RACH procedure. In another example, the 4-step procedure may be a contention-based RACH procedure.

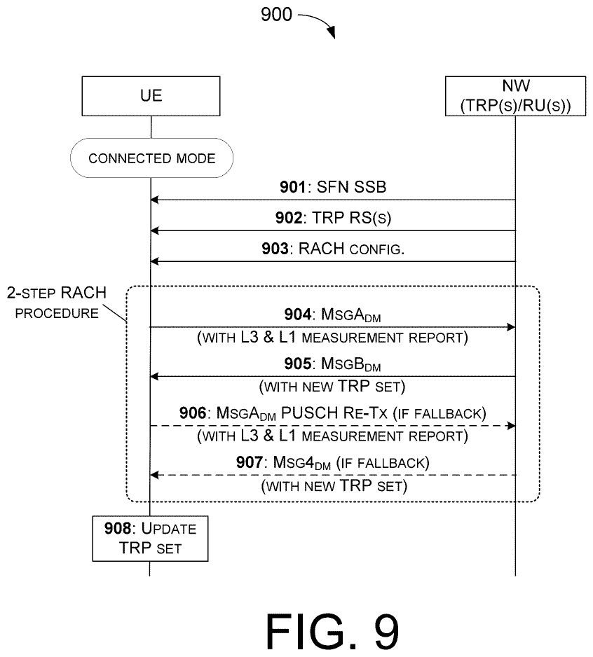

FIG. 9 illustrates an example scenario 900 of DL-based TRP set selection using 2-step RACH procedure in accordance with an implementation of the present disclosure. To begin with, the UE first connects to one or more TRPs/RU(s) (i.e., the originally serving TRP set) to operate in the connected mode. In step 901, the UE receives an SFN SSB for cell search (CS) or for connection management (CM), wherein the same SFN SSB is received from multiple TRPs within an SFN area. For example, the UE may perform a measurement of the SFN SSB for rough time-frequency tracking. In step 902, the UE receives one or more TRP RSs for TRP set update, wherein different TRP RSs are received from different TRPs within the SFN area, and each TRP RS includes the TRP ID and TRP timing of a respective TRP. For example, the UE may perform L3 and L1 measurements based on the SFN SSB and/or the TRP RS(s) for coarse time-frequency tracking. The specific TRP for timing reference and/or power ramping reference may be the primary TRP which may be specified (or configured/commanded/indicated) by NW or selected and reported by UE. In step 903, the UE receives a RACH configuration, e.g., via an RRC configuration, wherein the RACH configuration may be a broadcast RACH configuration or a UE-specific RACH configuration. In one example, the RACH configuration may additionally or optionally contain a triggering condition for the UE to determine whether to initiate PRACH transmission.

Then, in step 904, the UE initiates the RACH procedure by transmitting a random access preamble (denoted as MsgA_{DM}) to the originally serving TRP set based on the RACH configuration, wherein the random access preamble includes a report of L3 and L1 measurements (e.g., including reference signal received power (RSRP), reference signal received quality (RSRQ), received signal strength indicator (RSSI), or signal-to-noise ratio (SNR) of the TRP(s) selected by the UE, and/or indications of whether synchronization with the TRP(s) has been completed). In one example, the UE may trigger the MsgA_{DM} transmission when the triggering condition received in the RACH configuration is met. In one example, the UE may trigger the MsgA_{DM} transmission based on its own measurement results, e.g., the RSRP of the primary TRP or any selected TRP(s) within the originally serving TRP set. In one example, the UE may trigger the MsgA_{DM} transmission when it receives a TRP switching configuration/command/indication from the originally serving TRP set. In one example, the content of MsgA_{DM} may include information similar to legacy NR MsgA of contention-free RACH procedure. In one example, the PRACH sequence of MsgA_{DM} may not be UE-specific, and the information related to the UE ID may be provided in MsgA_{DM}. In one example, the PRACH sequence of MsgA_{DM} may be UE-specific, and the information related to the UE ID may not be provided in MsgA_{DM}. In one example, the UE may additionally determine the new TRP set and report the new TRP set to NW via MsgA_{DM}. In one example, the UE may additionally report the receiving timing difference (RTD) between a selected TRP(s) and the primary TRP to NW via MsgA_{DM}. In one example, the UE may additionally report spatial profile estimation result and/or channel estimation result of the selected TRP(s) to NW via MsgA_{DM}. The aforementioned selected TRP(s) may refer to each TRP within the new TRP set selected by the UE, or each TRP specified by NW in advance.

Next, in step 905, the UE receives a random access response (denoted as MsgB_{DM}) from the originally serving TRP set, wherein the random access response includes (or confirms) the new TRP set. In one example, the content of MsgB_{DM} may include information similar to legacy NR MsgB of contention-free RACH procedure. In one example, the NW may confirm the target UE by providing information related to the UE ID of the target UE. In one example, the new TRP set may be the new TRP set reported by the UE in MsgA_{DM}, or may be a TRP set determined by NW based on the new TRP set reported by the UE in MsgA_{DM}. In one example, NW may additionally assign the timing advance (TA) value(s) to a subset of the TRPs within the new TRP set to the UE via MsgB_{DM}. The subset may contain only one TRP or all TRPs in the new TRP set. The TA value(s) may be based on a (reference/primary) TRP within the current serving TRP(s) or within the newly indicated TRP(s). The TA value(s) may be common in the subset of TRPs or may be TRP-specific.

Subsequently, in step 906, the UE may retransmit MsgA_{DM} on physical uplink shared channel (PUSCH) if MsgB_{DM} contains a fallbackRAR indicator (which means that NW does not successfully receive MsgA_{DM}). In one example, the content of retransmitted MsgA_{DM} may include information similar to legacy NR fallback-MsgA of contention-free RACH procedure. In step 907, the UE may receive a random access response (denoted as Msg4_{DM}) from the originally serving TRP set, wherein the random access response includes (or confirms) the new TRP set. In one example, the content of Msg4_{DM} may include information similar to legacy NR fallback-Msg4 of contention-free RACH procedure. In one example, the new TRP set may be the new TRP set reported by the UE in MsgA_{DM}, or may be a TRP set determined by NW based on the new TRP set reported by the UE in MsgA_{DM}. In step 908, the UE updates the originally serving TRP set based on the received new TRP set, i.e., the UE switches from the originally serving TRP set to the new TRP set.

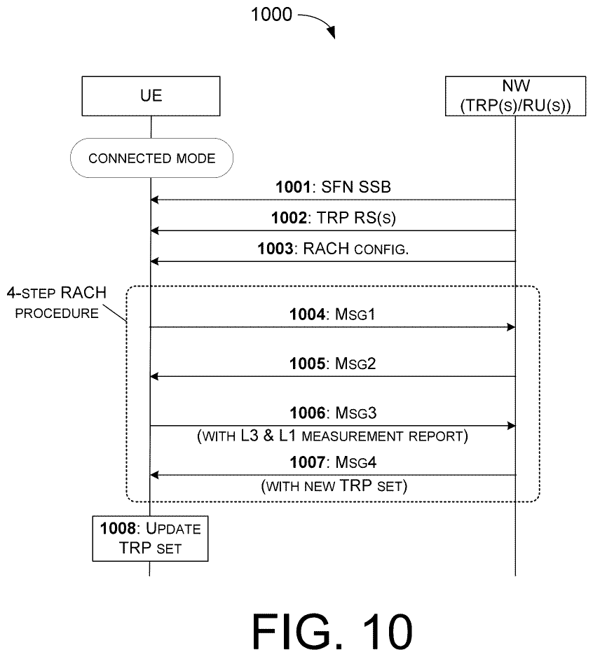

FIG. 10 illustrates an example scenario 1000 of DL-based TRP set selection using 4-step RACH procedure in accordance with an implementation of the present disclosure. Similar to steps 901-903 in FIG. 9, the UE of FIG. 10 receives an SFN SSB for CS/CM, then receives one or more TRP RSs for TRP set update, and subsequently receives broadcast or UE-specific RACH configuration (steps 1001-1003). Next, in step 1004, the UE initiates the RACH procedure by transmitting a random access preamble (denoted as Msg1) to the originally serving TRP set based on the RACH configuration, wherein the transmission of the random access preamble may be is triggered based on one of the following: (i) the trigger condition provided in the RACH configuration; (ii) the UE's measurement results, e.g., the RSRP of the primary TRP or any selected TRP(s) within the originally serving TRP set; and (iii) a TRP switching configuration/command/indication received from the originally serving TRP set. In one example, the content of Msg1 may include information similar to legacy NR Msg1 of contention-based RACH procedure. In one example, the PRACH sequence of Msg1 may not be UE-specific, and the information related to the UE ID may be provided in Msg1. In one example, the PRACH sequence of Msg1 may be UE-specific, and the information related to the UE ID may not be provided in Msg1.

Then, in step 1005, the UE receives a random access response (denoted as Msg2) from the originally serving TRP set, wherein the random access response indicates an UL grant. In one example, the content of Msg2 may include information similar to legacy NR Msg2 of contention-based RACH procedure. In step 1006, the UE transmits a message of scheduled transmission (denoted as Msg3) to the originally serving TRP based on the UL grant, wherein the message of scheduled transmission includes a report of L3 and L1 measurements (e.g., including RSRP/RSRQ/RSSI of the TRP(s) selected by the UE). In one example, the content of Msg3 may include information similar to legacy NR Msg3 of contention-based RACH procedure (e.g., information related to UE ID may be provided in Msg3). In one example, the UE may additionally determine the new TRP set and report the new TRP set to NW via Msg3. In one example, the UE may additionally report the RTD between a selected TRP(s) and the primary TRP to NW via Msg3. In one example, the UE may additionally report spatial profile estimation result and/or channel estimation result of the selected TRP(s) to NW via Msg3. The aforementioned selected TRP(s) may refer to each TRP within the new TRP set selected by the UE, or each TRP specified by NW in advance.

Subsequently, in step 1007, the UE receives a message of contention resolution (denoted as Msg4) from the originally serving TRP set, wherein the message of contention resolution includes (or confirms) the new TRP set. In one example, the content of Msg4 may include information similar to legacy NR Msg4 of contention-based RACH procedure. In one example, the new TRP set may be the new TRP set reported by the UE in Msg3, or may be a TRP set determined by NW based on the new TRP set reported by the UE in Msg3. In one example, NW may additionally assign the TA value(s) to a subset of the TRPs within the new TRP set to the UE via Msg4. The subset may contain only one TRP or all TRPs in the new TRP set. The TA value(s) may be based on a (reference/primary) TRP within the current serving TRP(s) or within the newly indicated TRP(s). The TA value(s) may be common in the subset of TRPs or may be TRP-specific. After that, in step 1008, the UE updates the originally serving TRP set based on the received new TRP set, i.e., the UE switches from the originally serving TRP set to the new TRP set.

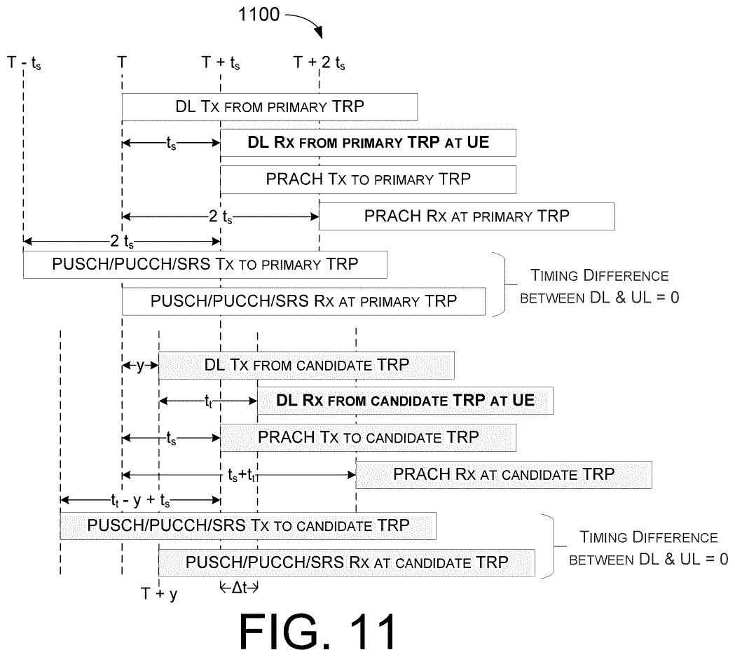

Under the fourth proposed scheme of the present disclosure, procedures related to derivation/adjustment of the clock error between TRPs and determination of TA of multiple TRPs are proposed. FIG. 11 illustrates an example scenario 1100 of derivation/adjustment of the clock error between TRPs in accordance with an implementation of the present disclosure. In scenario 1100, NW may derive/adjust clock error between TRPs by the following procedure. In stage 1 of the procedure, the UE may perform TA-acquisition transmission (e.g., by assuming that TA estimation toward primary TRP has been done and tₛ is known already). The TA-acquisition transmission towards candidate TRP may be based on the reference timing (e.g., DL reception timing) of the primary TRP, and NW may inform the UE of the estimated TA which may be represented by the following equation:

$$T {A}_{candidate} = ( T + {t}_{s} + {t}_{t} ) - ( T + y ) = {t}_{s} + {t}_{t} - y$$

On the other hand, the UE may apply TA_{target} based on the reference timing of the primary TRP, and the UL transmission towards the candidate TRP may be at: (T+tₛ)−(tₛ+tₜ−y)=T+y−tₜ. In stage 2 of the procedure, the UE may estimate the DL reception time difference between the primary TRP and the candidate TRP by the following equation:

$$Δ t = {t}_{candidate} - {t}_{primary} = ( T + y + {t}_{t} ) - ( T + {t}_{s} ) = y + {t}_{t} - {t}_{s} ,$$

where t_{candidate} denotes the DL reception timing of the candidate TRP, and t_{primary} denotes the DL reception timing of the primary TRP. In stage 3 of the procedure, the UE may report Δt to NW. In stage 4 of the procedure, NW may derive the clock error between the primary TRP and the candidate TRP as follows:

$$\begin{matrix}{y}^{′} = [ ( Δ t - T {A}_{candidate} ) + 2 {t}_{s} ] / 2 \\ = [ ( y + {t}_{t} - {t}_{s} ) - ( {t}_{s} + {t}_{t} - y ) + 2 {t}_{s} ] / 2 \\ = [ 2 y - 2 {t}_{s} + 2 {t}_{s} ] / 2 = y\end{matrix}$$

In stage 5 of the procedure, NW may derive/adjust the clock error (i.e., y) to ensure coherent joint transmission (CJT).

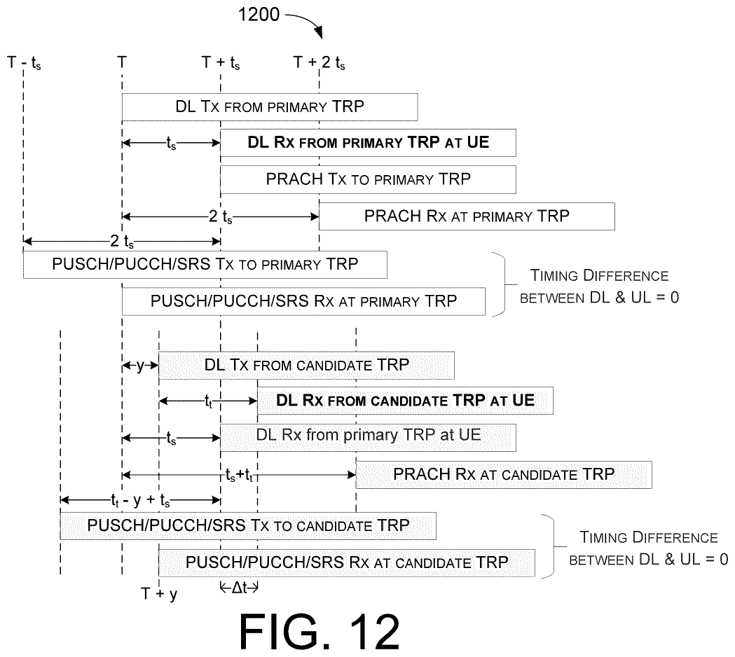

FIG. 12 illustrates an example scenario 1200 of determination of TA of multiple TRPs in accordance with an implementation of the present disclosure. In scenario 1200, the UE may apply the TA of multiple TRPs by the following procedure. In stage 1 of the procedure, the UE may perform TA-acquisition transmission (e.g. by assuming that the TA estimation towards the primary TRP has been done and tₛ is known already). The TA-acquisition transmission towards the candidate TRP may be based on the reference timing (e.g., DL reception timing) of the primary TRP, where the estimated TA may be represented by the following equation:

$$T {A}_{candidate} = ( T + {t}_{s} + {t}_{t} ) - ( T + y ) = {t}_{s} + {t}_{t} - y$$

In stage 2 of the procedure, NW may inform the UE of the estimated TA (i.e., TA_{candidate}). In stage 3 of the procedure, the UE may apply TA_{candidate} based on the reference timing of the primary TRP, and the UL transmission towards the candidate TRP will be (T+tₛ)−(tₛ+tₜ−y)=T+y−tₜ. In stage 4 of the procedure, NW may receive the UL transmission from the UE at timing point denoted as follows:

$$( T + y - {t}_{t} ) + ( {t}_{t} ) = T + y$$

Under the fifth proposed scheme of the present disclosure, an UL-assisted approach for fast TRP set selection is proposed, e.g., to deal with certain challenge in the DL-based approach. Specifically, when TRPs are deployed densely, boundary crossings (i.e., serving TRP selection) between TRPs will increase, causing prolonged measurement reporting latency and increased handover failure rate. To address this issue, the DL-based approach needs to be adapted to shorten the periodicity of the TRP RS but this adaptation would present a challenge of causing a significant impact on the system overhead. To rise to the challenge, the UL-assisted approach based on UE's UL RS (e.g., PRACH or SRS) transmission may provide more flexibility in terms of signal configuration because UL RS is UE-specific and the UL RS generally has a shorter periodicity compared to the DL TRP RS. In one example, the UL RS may be transmitted periodically (e.g., with a shorter periodicity compared to the DL TRP RS). In another example, the UL RS may be transmitted on-demand when certain conditions are met.

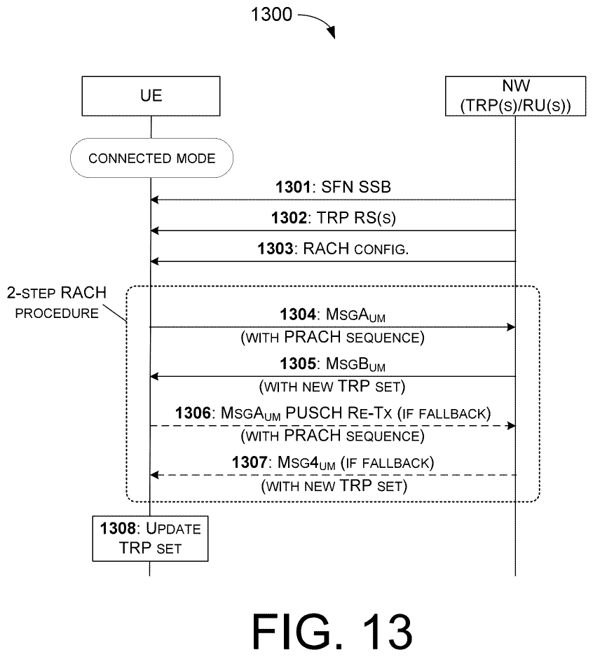

FIG. 13 illustrates an example scenario 1300 of RACH-based UL-assisted TRP set selection in accordance with an implementation of the present disclosure. Similar to steps 901-903 in FIG. 9, the UE of FIG. 13 receives an SFN SSB for CS/CM, then receives one or more TRP RSs for TRP set update, and subsequently receives broadcast or UE-specific RACH configuration (steps 1301-1303). Next, in step 1304, the UE initiates a 2-step RACH procedure by transmitting a random access preamble (denoted as MsgA_{UM}) to the originally serving TRP set based on the RACH configuration, wherein the transmission of the random access preamble may be is triggered based on one of the following: (i) the trigger condition provided in the RACH configuration; (ii) the UE's measurement results, e.g., the RSRP of the primary TRP or any selected TRP(s) within the originally serving TRP set; and (iii) a TRP switching configuration/command/indication received from the originally serving TRP set. In one example, the content of MsgA_{UM} may include information (e.g., PRACH sequence) similar to legacy NR MsgA of contention-free RACH procedure. In one example, MsgA_{UM} may be transmitted multiple times in a certain period. In one example, the UE may additionally report the RTD between a selected TRP(s) and the primary TRP to NW via MsgA_{UM}. In one example, the UE may additionally report a report of L3 and L1 measurements (e.g., including RSRP/RSRQ/RSSINR of selected TRP(s)) to NW via MsgA_{UM}. In one example, the UE may additionally report spatial profile estimation result and/or channel estimation result of the selected TRP(s) to NW via MsgA_{UM}. The aforementioned selected TRP(s) may refer to any TRP that the UE has done corresponding measurement, or each TRP specified by NW in advance.

Then, in step 1305, the UE receives a random access response (denoted as MsgB_{UM}) from the originally serving TRP set, wherein the random access response indicates the new TRP set which is measured and determined by NW based on the PRACH transmitted by the UE. In one example, the content of MsgB_{UM} may include information similar to legacy NR MsgB of contention-free RACH procedure. In one example, NW may additionally assign a TA value to each TRP within the new TRP set to the UE via MsgB_{UM}. The TA value may be based on a (reference/primary) TRP within its current serving TRP(s) or within the newly indicated TRP(s). In one example, reception of MsgB_{UM} is within a (pre-) configured time window. In one example, the UE does not trigger retransmission of MsgA_{UM} (PRACH+message part) if it failed to detect MsgB_{UM}.

Subsequently, in step 1306, the UE may retransmit MsgA_{UM} on PUSCH if MsgB_{UM} contains a fallbackRAR indicator (which means that NW does not successfully receive MsgA_{UM}). In one example, the content of retransmitted MsgA_{UM} may include information similar to legacy NR fallback-MsgA of contention-free RACH procedure. In step 1307, the UE may receive a random access response (denoted as Msg4_{UM}) from the originally serving TRP set, wherein the random access response indicates the new TRP set which is measured and determined by NW based on the PRACH retransmitted by the UE. In one example, the content of Msg4_{UM} may include information similar to legacy NR fallback-Msg4 of contention-free RACH procedure. In one example, NW may additionally assign a TA value to each TRP within the new TRP set to the UE via Msg4_{UM}. The TA value may be based on a (reference/primary) TRP within its current serving TRP(s) or within the newly indicated TRP(s). After that, in step 1308, the UE updates the originally serving TRP set based on the received new TRP set, i.e., the UE switches from the originally serving TRP set to the new TRP set.

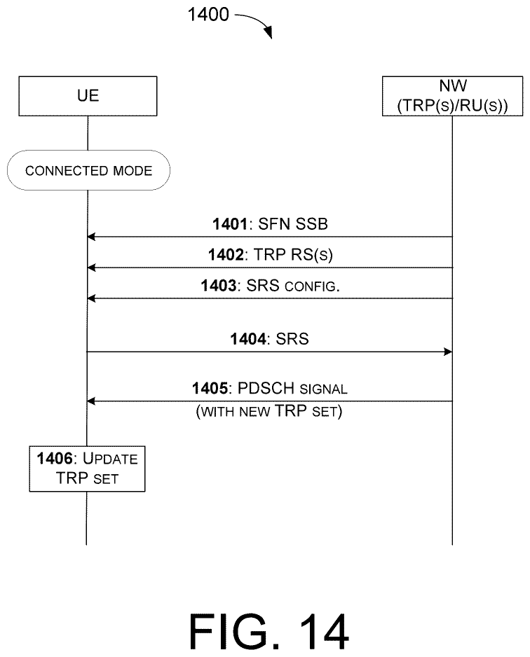

FIG. 14 illustrates an example scenario 1400 of SRS-based UL-assisted TRP set selection in accordance with an implementation of the present disclosure. Similar to steps 901-902 in FIG. 9, the UE of FIG. 14 receives an SFN SSB for CS/CM, and then receives one or more TRP RSs for TRP set update, and subsequently receives broadcast or UE-specific RACH configuration (steps 1402-1402). Next, in step 1403, the UE receives UE-specific SRS configuration from the originally serving TRP set. In one example, the SRS configuration may be the same as the SRS configuration for CSI acquisition. In one example, the SRS configuration may be the configuration of a 1-port SRS (i.e., different from the SRS for CSI acquisition). Subsequently, in step 1404, the UE transmits an SRS to the originally serving TRP set based on the SRS configuration, wherein the SRS transmission may be is triggered based on one of the following: (i) the trigger condition provided in the SRS configuration; (ii) the UE's measurement results, e.g., the RSRP of the primary TRP or any selected TRP(s) within the originally serving TRP set; and (iii) a TRP switching configuration/command/indication received from the originally serving TRP set. In one example, the UL power control for the SRS transmission may use fixed Tx power which may be derived based on the SRS configuration. In one example, the UL power control for the SRS transmission may use adaptive Tx power which may be adjusted based on the triggering DCI of the SRR (e.g., when the SRS is triggered aperiodically by DCI signaling). In one example, the UL power control for the SRS transmission may be different from (or the same as) the control loop for PUSCH and/or SRS for CSI. In one example, the transmission timing reference may follow a TRP which is determined based on NW indication (i.e., the TRP for reference timing may be adjusted based on NW indication). In one example, the transmission timing reference may follow a primary TRP which may be determined based on NW indication of TRP set decisioning/indication.

Then, in step 1405, the UE receives a physical downlink shared channel (PDSCH) signal from the originally serving TRP set, wherein the PDSCH signal indicates the new TRP set which is measured and determined by NW based on the SRS transmitted by the UE. In one example, NW may additionally assign a TA value to each TRP within the new TRP set to the UE via the PDSCH signal. In one example, NW may additionally indicate a primary TRP among the new TRP set via the PDSCH signal. In one example, NW may additionally indicate a reference TRP among the new TRP set via the PDSCH signal. In one example, NW may additionally provide UL power control information for the SRS transmission via the PDSCH signal. After that, in step 1406, the UE updates the originally serving TRP set based on the received new TRP set, i.e., the UE switches from the originally serving TRP set to the new TRP set.

Additionally, or optionally, a RACH procedure subsequent to step 1406 may be performed between the UE and NW. In one example, the RACH procedure may be triggered after/by the reception of the PDSCH signal including the new TRP set. In one example, the RACH procedure may be triggered by the DCI signaling which indicates the resource allocation of the PDSCH signal. Alternatively, the PDSCH signal including the new TRP set is not transmitted by NW and the RACH procedure is triggered, such that the new TRP set decision may be carried in the RACH messages as described in the third proposed scheme of the present disclosure.

### Illustrative Implementations

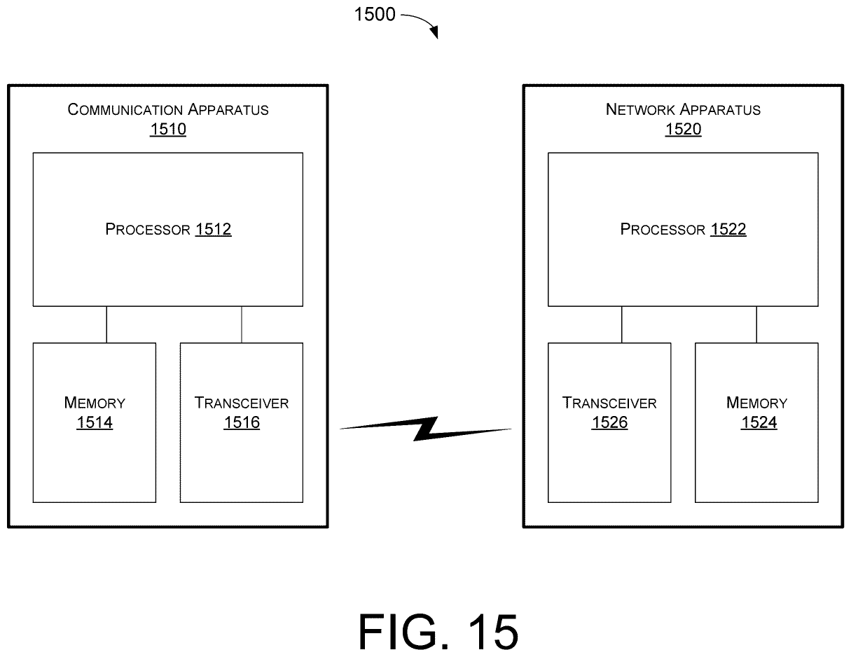

FIG. 15 illustrates an example communication system 1500 having an example communication apparatus 1510 and an example network apparatus 1520 in accordance with an implementation of the present disclosure. Each of communication apparatus 1510 and network apparatus 1520 may perform various functions to implement schemes, techniques, processes and methods described herein pertaining to tiered RRM with connected-mode mobility management in mobile communications, including scenarios/schemes described above as well as processes 1600 and 1700 described below.

Communication apparatus 1510 may be a part of an electronic apparatus, which may be a UE such as a portable or mobile apparatus, a wearable apparatus, a wireless communication apparatus or a computing apparatus. For instance, communication apparatus 1510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 1510 may also be a part of a machine type apparatus, which may be a ReCap UE, an IoT, NB-IoT, eMTC, IIoT UE such as an immobile or a stationary apparatus, a home apparatus, a roadside unit (RSU), a wire communication apparatus or a computing apparatus. For instance, communication apparatus 1510 may be implemented in a smart thermostat, a smart fridge, a smart door lock, a wireless speaker or a home control center. Alternatively, communication apparatus 1510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1510 may include at least some of those components shown in FIG. 15 such as a processor 1512, for example. Communication apparatus 1510 may further include one or more other components not pertinent to the proposed scheme of the present disclosure (e.g., internal power supply, display device and/or user interface device), and, thus, such component(s) of communication apparatus 1510 are neither shown in FIG. 15 nor described below in the interest of simplicity and brevity.

Network apparatus 1520 may be a part of an electronic apparatus, which may be a network node such as a TRP, an RU, a small cell, a router or a gateway of a wireless network. For instance, network apparatus 1520 may be implemented in a TRP/RU in a 4G/5G/6G, IoT, NB-IoT or IIoT network. Alternatively, network apparatus 1520 may be implemented in the form of one or more IC chips such as, for example and without limitation, one or more single-core processors, one or more multi-core processors, or one or more RISC or CISC processors. Network apparatus 1520 may include at least some of those components shown in FIG. 15 such as a processor 1522, for example. Network apparatus 1520 may further include one or more other components not pertinent to the proposed scheme of the present disclosure (e.g., internal power supply, display device and/or user interface device), and, thus, such component(s) of network apparatus 1520 are neither shown in FIG. 15 nor described below in the interest of simplicity and brevity.

In one aspect, each of processor 1512 and processor 1522 may be implemented in the form of one or more single-core processors, one or more multi-core processors, or one or more CISC processors. That is, even though a singular term “a processor” is used herein to refer to processor 1512 and processor 1522, each of processor 1512 and processor 1522 may include multiple processors in some implementations and a single processor in other implementations in accordance with the present disclosure. In another aspect, each of processor 1512 and processor 1522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1512 and processor 1522 is a special-purpose machine specifically designed, arranged and configured to perform specific tasks, including tiered RRM with connected-mode mobility management, in a device (e.g., as represented by communication apparatus 1510) and a network node (e.g., as represented by network apparatus 1520) in accordance with various implementations of the present disclosure.

In some implementations, communication apparatus 1510 may also include a transceiver 1516 coupled to processor 1512 and capable of wirelessly transmitting and receiving data. In some implementations, transceiver 1516 may be capable of wirelessly communicating with different types of UEs and/or wireless networks of different radio access technologies (RATs), such as 4G/5G/B5G/6G. In some implementations, transceiver 1516 may be equipped with a plurality of antenna ports (not shown) such as, for example, four antenna ports. That is, transceiver 1516 may be equipped with multiple transmit antennas and multiple receive antennas for MIMO wireless communications. In some implementations, network apparatus 1520 may also include a transceiver 1526 coupled to processor 1522. Transceiver 1526 may include a transceiver capable of wirelessly transmitting and receiving data. In some implementations, transceiver 1526 may be capable of wirelessly communicating with different types of UEs of different RATs. In some implementations, transceiver 1526 may be equipped with a plurality of antenna ports (not shown) such as, for example, four antenna ports. That is, transceiver 1526 may be equipped with multiple transmit antennas and multiple receive antennas for MIMO wireless communications.

In some implementations, communication apparatus 1510 may further include a memory 1514 coupled to processor 1512 and capable of being accessed by processor 1512 and storing data therein. In some implementations, network apparatus 1520 may further include a memory 1524 coupled to processor 1522 and capable of being accessed by processor 1522 and storing data therein. Each of memory 1514 and memory 1524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1514 and memory 1524 may include a type of read-only memory (ROM) such as mask ROM, programmable ROM (PROM), erasable programmable ROM (EPROM) and/or electrically erasable programmable ROM (EEPROM). Alternatively, or additionally, each of memory 1514 and memory 1524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 1510 and network apparatus 1520 may be a communication entity capable of communicating with each other using various proposed schemes in accordance with the present disclosure. For illustrative purposes and without limitation, a description of capabilities of communication apparatus 1510, as a UE, and network apparatus 1520, as a network node (e.g., TRP or RU), is provided below with processes 1600 and 1700.

### Illustrative Processes

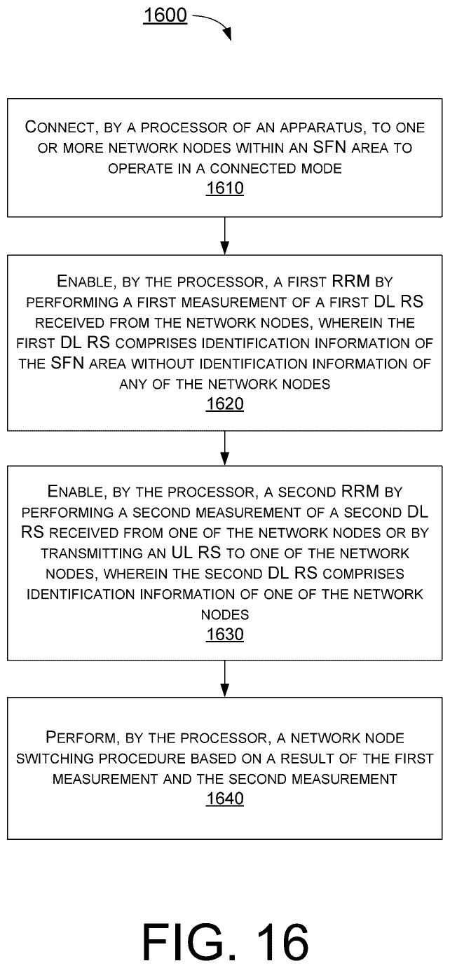

FIG. 16 illustrates an example process 1600 in accordance with an implementation of the present disclosure. Process 1600 may be an example implementation of above scenarios/schemes, whether partially or completely, with respect to tiered RRM with connected-mode mobility management in mobile communications. Process 1600 may represent an aspect of implementation of features of communication apparatus 1510. Process 1600 may include one or more operations, actions, or functions as illustrated by one or more of blocks 1610 to 1640. Although illustrated as discrete blocks, various blocks of process 1600 may be divided into additional blocks, combined into fewer blocks, or eliminated, depending on the desired implementation. Moreover, the blocks of process 1600 may be executed in the order shown in FIG. 7 or, alternatively, in a different order. Process 1600 may be implemented by communication apparatus 1510 or any suitable UE or machine type devices. Solely for illustrative purposes and without limitation, process 1600 is described below in the context of communication apparatus 1510. Process 1600 may begin at block 1610.

At 1610, process 1600 may involve processor 1512 of communication apparatus 1510 connecting, via transceiver 1516, to one or more network nodes within an SFN area to operate in a connected mode. Process 1600 may proceed from 1610 to 1620.

At 1620, process 1600 may involve processor 1512 enabling a first RRM (e.g., outer-loop RRM) by performing a first measurement of a first DL RS received from the network nodes, wherein the first DL RS comprises identification information of the SFN area without identification information of any of the network nodes. Process 1600 may proceed from 1620 to 1630.

At 1630, process 1600 may involve processor 1512 enabling a second RRM (e.g., inner-loop RRM) by performing a second measurement of a second DL RS received from the network nodes or by transmitting an UL RS to the network nodes, wherein the second DL RS comprises identification information of the network nodes. Process 1600 may proceed from 1630 to 1640.

At 1640, process 1600 may involve processor 1512 performing a network node switching procedure based on a result of the first measurement and the second measurement.

In some implementations, the first DL RS may include a PBCH and at least one of a PSS and a first SSS, and the second DL RS may include a second SSS, a CSI-RS, or a multi-port RS.

In some implementations, the network node switching procedure when transmitting the UL RS for the second RRM may include: (i) transmitting a first message after consecutive UL RS transmissions to one of the network nodes, wherein the first message comprises a report of the result of the first measurement and the second measurement, and/or a first set of network nodes (e.g., to request for switching); (ii) receiving a second message from one of the network nodes, wherein the second message indicates a second set of network nodes (e.g., for switching) or indicates a retransmission of the first message; and (iii) switching from the network nodes to the second set of network nodes. The number of selected network nodes for reporting might be larger than the number of the first set of network nodes.

In some implementations, the network node switching procedure may further include: (i) retransmitting the first message to one of the network nodes in an event that the second message indicates the retransmission of the first message; and (ii) receiving a third message from one of the network nodes in an event that the second message indicates the retransmission of the first message, wherein the third message indicates the second set of network nodes.

In some implementations, the transmitting of the first message may be triggered based on one of the following: (i) a trigger condition in a configuration received from one of the network nodes; (ii) the result of the first measurement and the second measurement; and (iii) an event that an indication of network node switching is received from one of the network nodes.

In some implementations, the first set of network nodes may be selected by communication apparatus 1510 based on the result of the first measurement and the second measurement, and the first message may further include at least one of the following: (i) a respective RTD between a primary network node and each of the selected network nodes; and (ii) a spatial profile estimation result of the selected network nodes; and (iii) a channel estimation result of the selected network nodes.

In some implementations, the second set of network nodes may include the first set of network nodes or is determined based on the first set of network nodes.

In some implementations, the second message may further include one or more TA values associated with one or more network nodes in the second set of network nodes.

In some implementations, the network node switching procedure when performing the second measurement of the second DL RS for the second RRM may include: (i) transmitting a first message to one of the network nodes; (ii) receiving a second message from one of the network nodes, wherein the second message indicates an UL grant; (iii) transmitting a third message to one of the network nodes based on the UL grant, wherein the third message comprises a report of the result of the first measurement and the second measurement, and a first set of network nodes (e.g., to request for switching); (iv) receiving a fourth message from one of the network nodes, wherein the fourth message indicates a second set of network nodes (e.g., for switching); and (v) switching from the network nodes to the second set of network nodes.

In some implementations, the transmitting of the first message may be triggered based on one of the following: (i) a trigger condition in a configuration received from one of the network nodes; (ii) the result of the first measurement and the second measurement; and (iii) an event that an indication of network node switching is received from one of the network nodes.

In some implementations, the first set of network nodes may be selected by communication apparatus 1510 based on the result of the first measurement and the second measurement, and the third message may further include at least one of the following: (i) a respective RTD between a primary network node and each of the selected network nodes; (ii) a spatial profile estimation result of the selected network nodes; and (iii) a channel estimation result of the selected network nodes.

In some implementations, the second set of network nodes may include the first set of network nodes or may be determined based on the first set of network nodes.

In some implementations, the second message may further include one or more TA values associated with one or more network nodes in the second set of network nodes.

In some implementations, the UL RS may include a PRACH signal or an SRS; or the transmitting of the UL RS may be performed periodically or aperiodically or may be triggered based on one of the following: (i) a trigger condition in a configuration received from one of the network nodes; (ii) the result of the first measurement and the second measurement; and (iii) an event that an indication of network node switching is received from one of the network nodes.

In some implementations, the message transmitted after consecutive UL RS, i.e. PRACH signal, may include at least one of the following: (i) a report of the first measurement and the second measurement; (ii) a respective RTD between a primary network node and each of the network nodes; (iii) a spatial profile estimation result of the network nodes; and (iv) a channel estimation result of the network nodes. For instance, the above content may be included in a UL signal sent after the UL RS, if the operation required to obtain the above content is completed.

In some implementations, the network node switching procedure may include: (i) receiving a random access response from one of the network nodes in an event that the UL RS comprises the PRACH signal, or receiving a PDSCH signal from one of the network nodes in an event that the UL RS comprises the SRS, wherein the random access response or the PDSCH signal indicates a first set of network nodes; and (ii) switching from the network nodes to the first set of network nodes.

In some implementations, the random access response may include a respective TA values associated with each network node in the first set of network nodes, and/or the random access response may be received within a configured time window.

In some implementations, the PDSCH signal may include at least one of the following: (i) a respective TA values associated with each network node in the first set of network nodes; (ii) an indication of a primary network node among the first set of network nodes;

In some implementations, when the UL RS comprises the SRS, the SRS transmission based on a UE specific configuration provided by network, That configuration comprises at least one of the following: (i) an indication of a network node among the first set of network nodes as an SRS transmission timing reference; and (ii) UL power control information for the SRS transmission.

In some implementations, the SFN area may be corresponding to a DU or a cell, and each of the network nodes within the SFN area comprises a TRP or an RU.

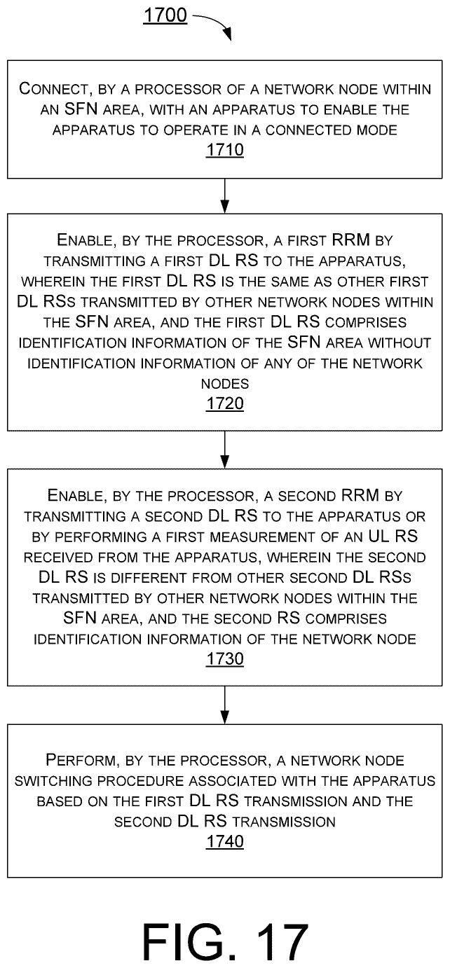

FIG. 17 illustrates an example process 1700 in accordance with an implementation of the present disclosure. Process 1700 may be an example implementation of above scenarios/schemes, whether partially or completely, with respect to tiered RRM with connected-mode mobility management in mobile communications. Process 1700 may represent an aspect of implementation of features of network apparatus 1520. Process 1700 may include one or more operations, actions, or functions as illustrated by one or more of blocks 1710 to 1740. Although illustrated as discrete blocks, various blocks of process 1700 may be divided into additional blocks, combined into fewer blocks, or eliminated, depending on the desired implementation. Moreover, the blocks of process 1700 may be executed in the order shown in FIG. 17 or, alternatively, in a different order. Process 1700 may be implemented by network apparatus 1520 or any suitable network node. Solely for illustrative purposes and without limitation, process 1700 is described below in the context of communication apparatus 1510, as a UE, and network apparatus 1520, as a network node (e.g., TRP/RU). Process 1700 may begin at block 1710.

At 1710, process 1700 may involve processor 1522 of network apparatus 1520 within an SFN area, connecting, via transceiver 1526, with communication apparatus 1510 to enable communication apparatus 1510 to operate in a connected mode. Process 1700 may proceed from 1710 to 1720.

At 1720, process 1700 may involve processor 1522 enabling a first RRM (e.g., outer-loop RRM) by transmitting a first DL RS to communication apparatus 1510, wherein the first DL RS is the same as other first DL RSs transmitted by other network nodes within the SFN area, and the first DL RS comprises identification information of the SFN area without identification information of any of the network nodes. Process 1700 may proceed from 1720 to 1730.

At 1730, process 1700 may involve processor 1522 enabling a second RRM (e.g., inner-loop RRM) by transmitting a second DL RS to communication apparatus 1510 or by performing a first measurement of an UL RS received from communication apparatus 1510, wherein the second DL RS is different from other second DL RSs transmitted by other network nodes within the SFN area, and the second DL RS comprises identification information of the network node. Process 1700 may proceed from 1730 to 1740.

At 1740, process 1700 may involve processor 1522 performing a network node switching procedure associated with communication apparatus 1510 based on the first DL RS transmission and the second DL RS transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of an apparatus, to one or more network nodes within a single frequency network (SFN) area to operate in a connected mode;
enabling, by the processor, a first radio resource management (RRM) by performing a first measurement of a first downlink (DL) reference signal (RS) received from the network nodes, wherein the first DL RS comprises identification information of the SFN area without identification information of any of the network nodes;
enabling, by the processor, a second RRM by performing a second measurement of a second DL RS received from the network nodes or by transmitting an uplink (UL) RS to the network nodes, wherein the second DL RS comprises identification information of the network nodes; and
performing, by the processor, a network node switching procedure based on a result of the first measurement and the second measurement.

2. The method of claim 1, wherein the first DL RS comprises a physical broadcast channel (PBCH) and at least one of a primary synchronization signal (PSS) and a first secondary synchronization signal (SSS), and the second DL RS comprises a second SSS, a channel state information-reference signal (CSI-RS), or a multi-port RS.

3. The method of claim 1, wherein the network node switching procedure when performing the second measurement of the second DL RS for the second RRM comprises:
transmitting a first message to one of the network nodes, wherein the first message comprises a report of the result of the first measurement and the second measurement, and a first set of network nodes;
receiving a second message from one of the network nodes, wherein the second message indicates a second set of network nodes or indicates a retransmission of the first message; and
switching from the network nodes to the second set of network nodes.

4. The method of claim 3, wherein the network node switching procedure further comprises:
retransmitting the first message to one of the network nodes in an event that the second message indicates the retransmission of the first message; and
receiving a third message from one of the network nodes in an event that the second message indicates the retransmission of the first message, wherein the third message indicates the second set of network nodes.

5. The method of claim 3, wherein the transmitting of the first message is triggered based on one of the following:
a trigger condition in a configuration received from one of the network nodes;
the result of the first measurement and the second measurement; and
an event that an indication of network node switching is received from one of the network nodes.

6. The method of claim 3, wherein the first set of network nodes are selected by the apparatus based on the result of the first measurement and the second measurement, and the first message further comprises at least one of the following:
a respective receiving timing difference (RTD) between a primary network node and each of the selected network nodes;
a spatial profile estimation result of the selected network nodes; and
a channel estimation result of the selected network nodes.

7. The method of claim 3, wherein the report of the result of the second measurement comprises at least one of the following:
a RSRP, RSRQ, or SINR of the selected network nodes;
an indication of whether synchronization has been completed for the selected network nodes.

8. The method of claim 3, wherein the second set of network nodes comprises the first set of network nodes or is determined based on the first set of network nodes.

9. The method of claim 4, wherein the second message or third message further comprises at least one of the following:
one or more timing advance (TA) values associated with one or more network nodes in the second set of network nodes;
an indication of a primary network node among the second set of network nodes.

10. The method of claim 1, wherein the network node switching procedure when performing the second measurement of the second DL RS for the second RRM comprises:
transmitting a first message to one of the network nodes;
receiving a second message from one of the network nodes, wherein the second message indicates an UL grant;
transmitting a third message to one of the network nodes based on the UL grant, wherein the third message comprises a report of the result of the first measurement and the second measurement, and a first set of network nodes;
receiving a fourth message from one of the network nodes, wherein the fourth message indicates a second set of network nodes; and
switching from the network nodes to the second set of network nodes.

11. The method of claim 10, wherein the transmitting of the first message is triggered based on one of the following:
a trigger condition in a configuration received from one of the network nodes;
the result of the first measurement and the second measurement; and
an event that an indication of network node switching is received from one of the network nodes.

12. The method of claim 10, wherein the first set of network nodes are selected by the apparatus based on the result of the first measurement and the second measurement, and the third message further comprises at least one of the following:
a respective receiving timing difference (RTD) between a primary network node and each of the selected network nodes;
a spatial profile estimation result of the selected network nodes; and
a channel estimation result of the selected network nodes.

13. The method of claim 10, wherein the report of the result of the second measurement comprises at least one of the following:
a RSRP, RSRQ, or SINR of the selected network nodes;
an indication of whether synchronization has been completed for the selected network nodes.

14. The method of claim 10, wherein the second set of network nodes comprises the first set of network nodes or is determined based on the first set of network nodes.

15. The method of claim 10, wherein the fourth message further comprises at least one of the following:
one or more TA values associated with one or more network nodes in the second set of network nodes;
an indication of a primary network node among the second set of network nodes.

16. The method of claim 1, wherein the network node switching procedure when transmitting the UL RS for the second RRM comprises:
transmitting a first message after consecutive UL RS transmissions to one of the network nodes, wherein the first message comprises a report of the result of the first measurement and the second measurement;
receiving a random access response from one of the network nodes in an event that the UL RS comprises the PRACH signal, or receiving a physical downlink shared channel (PDSCH) signal from one of the network nodes in an event that the UL RS comprises the SRS, wherein the random access response or the PDSCH signal indicates a first set of network nodes for switching; and
switching from the network nodes to the first set of network nodes.

17. The method of claim 16, wherein:
the UL RS for second RRM comprises a physical random access channel (PRACH) signal or a sounding reference signal (SRS); and
the transmitting of the UL RS is performed periodically or aperiodically, or is triggered based on one of the following:
a trigger condition in a configuration received from one of the network nodes;
the result of the first measurement and the second measurement; and
an event that an indication of network node switching is received from one of the network nodes.

18. The method of claim 16, wherein the first message transmitted after consecutive UL RS further comprises at least one of the following:
a respective receiving timing difference (RTD) between a primary network node and each of the network nodes;
a spatial profile estimation result of the network nodes; and
a channel estimation result of the network nodes.

19. The method of claim 16, wherein the report of the result of the second measurement comprises at least one of the following:
a RSRP, RSRQ, or SINR of the selected network nodes;
an indication of whether synchronization has been completed for the selected network nodes.

20. The method of claim 16, wherein the random access response is received within a configured time window, the random access response comprises at least one of the following:
a respective TA values associated with each network node in the first set of network nodes;
an indication of a primary network node among the first set of network nodes.

21. The method of claim 16, wherein the PDSCH signal comprises at least one of the following:
a respective TA values associated with each network node in the first set of network nodes;
an indication of a primary network node among the first set of network nodes.

22. The method of claim 17, wherein when the UL RS comprises the SRS, the SRS transmission based on a UE specific configuration provided by network, the UE specific configuration comprises at least one of the following:
an indication of a network node as an SRS transmission timing reference; and
UL power control information for the SRS transmission.

23. The method of claim 1, wherein the SFN area is corresponding to a distributed unit (DU) or a cell, and each of the network nodes within the SFN area comprises a transmission reception point (TRP) or a radio unit (RU).

24. A method, comprising:
connecting, by a processor of a network node within a single frequency network (SFN) area, with an apparatus to enable the apparatus to operate in a connected mode;
enabling, by the processor, a first radio resource management (RRM) by transmitting a first downlink (DL) reference signal (RS) to the apparatus, wherein the first DL RS is the same as other first DL RSs transmitted by other network nodes within the SFN area, and the first DL RS comprises identification information of the SFN area without identification information of any of the network nodes;
enabling, by the processor, a second RRM by transmitting a second DL RS to the apparatus or by performing a first measurement of an uplink (UL) RS received from the apparatus, wherein the second DL RS is different from other second DL RSs transmitted by other network nodes within the SFN area, and the second DL RS comprises identification information of the network node; and
performing, by the processor, a network node switching procedure associated with the apparatus based on the first DL RS transmission and the second DL RS transmission.
